(19) United States
(12) Patent Application Publication
(10) Pub. No.: US 2014/0025852 A1
(43) Pub. Date: Jan. 23, 2014

(54) Configurable Response Generator for Varied Regions of System Address Space

(71) Applicants: Sreenath Shambu Ramakrishna, Chintamani (IN); Srinivasa Rao Kothamasu, Bangalore (IN); Debjit Roy Choudhury, Kolkata (IN)

(72) Inventors: Sreenath Shambu Ramakrishna, Chintamani (IN); Srinivasa Rao Kothamasu, Bangalore (IN); Debjit Roy Choudhury, Kolkata (IN)

(73) Assignee: LSI CORPORATION, Milpitas, CA (US)

(21) Appl. No.: 13/553,255

(22) Filed: Jul. 19, 2012

(51) Int. Cl. G06F 13/14

(52) U.S. Cl. 710/110

(57) ABSTRACT

A bus interconnect for interconnecting one or more master devices with one or more slave devices in a system includes at least one slave interface module adapted for communicating with a corresponding one of the master devices and at least one master interface module adapted for communicating with a corresponding one of the slave devices. The bus interconnect further includes a configurable response module coupled with the slave interface module. The configurable response module is operative to generate different configurable responses associated with access requests to corresponding portions of an address space of the system.

### BACKGROUND

In a system-on-a-chip (SoC) application, an entire system address space is typically partitioned into multiple regions in accordance with end-user/application requirements. These regions associate to different system peripherals, wherein masters or processors access the peripherals through multilevel interconnect networks. Additionally, these address regions are associated with varied attributes (e.g., read only, write only, constant data access, no access, etc.) for data and instruction accesses. Some of these attributes (e.g., read only, write only, no access) are addressed using a memory management unit (MMU) or memory programming unit (MPU) in a processor-based system. For masters other than processors, this specific behavior is handled either at the interconnect level or using specific peripherals. However, existing implementations of an interconnect network are not exhaustive enough to support all application requirements, and specific peripheral implementations will add additional access latency and area overhead due to varied bus protocols and operating frequencies, which are thus impractical or undesirable.

### SUMMARY

Embodiments of the invention advantageously provide novel methods and apparatus for affording configurable responses to a master device or processor adapted to access one or more slave or peripheral devices through a bus interconnect. Methods and apparatus according to embodiments of the invention facilitate efficient addressing of different system address region attributes in such a manner that the number of logic gates, congestion in the bus interconnect, and power consumption are beneficially reduced, among other benefits.

In accordance with an embodiment of the invention, a bus interconnect for interconnecting one or more master devices with one or more slave devices in a system includes at least one slave interface module adapted for communicating with a corresponding one of the master devices and at least one master interface module adapted for communicating with a corresponding one of the slave devices. The bus interconnect further includes a configurable response module coupled with the slave interface module(s). The configurable response module is operative to generate different configurable responses associated with access requests to corresponding portions of an address space of the system.

Embodiments of the invention will become apparent from the following detailed description thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is a block diagram depicting at least a portion of an illustrative data processing system in which embodiments of the invention may be implemented;

FIG. 2 is a table conceptually depicting an exemplary system memory mapping for a four-gigabyte (GB) address space;

FIG. 3 is a block diagram depicting at least a portion of an exemplary system configurable for implementing the memory mapping shown in FIG. 2;

FIG. 4 is a block diagram depicting at least a portion of an exemplary interconnect architecture, according to an embodiment of the invention;

FIG. 5 is a table conceptually depicting an exemplary register programming, according to an embodiment of the invention; and

FIG. 6 is a block diagram depicting at least a portion of an exemplary electronic system adapted to perform methodologies according to embodiments of the invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Embodiments of the invention will be described herein in the context of illustrative methods and/or apparatus for generating configurable responses for multiple regions of address space in a multiprocessor system in a manner which advantageously reduces system hardware (i.e., logic) requirements, reduces network interconnect congestion, reduces integrated circuit area, reduces overall power consumption in the system and improves system performance, among other benefits. It should be understood, however, that embodiments of the invention are not limited to these or any other particular methods and/or apparatus. While embodiments of the invention may be described herein with reference to specific address ranges or mappings, it is to be understood that the embodiments of the invention are not limited to the ranges or mappings shown and described herein, and that embodiments of the invention can be performed using other memory ranges or mappings, as will become apparent to those skilled in the art. Moreover, it will become apparent to those skilled in the art given the teachings herein that numerous modifications can be made to the embodiments shown that are within the scope of the claimed invention. That is, no limitations with respect to the embodiments shown and described herein are intended or should be inferred.

As a preliminary matter, for the purposes of clarifying and describing embodiments of the invention, the following table provides a summary of certain acronyms and their corresponding definitions, as the terms are used herein:

Table of Acronym Definitions

| Acronym | Definition |
|---|---|
| SoC | System-on-a-chip |
| DMA | Direct memory access |
| ROM | Read-only memory |
| RAM | Random access memory |
| I/O | Input/output |
| GB | Gigabyte |
| DMA | Direct memory access |
| APB | Advanced Peripheral Bus |
| AXI | Advanced eXtensible Interface |
| AHB | Advanced High-performance Bus |
| QoS | Quality of service |
| CPU | Central processing unit |
| ASIC | Application-specific integrated circuit |

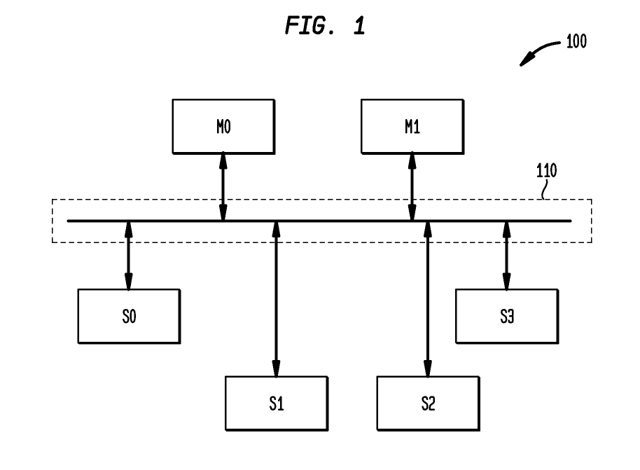

In modern data processing systems, bus interconnects or alternative connection means (e.g., bus matrix, etc.) are often used for routing data from high-performance “masters” or processors to corresponding “slaves” or peripherals in operative communication with the masters. FIG. 1 is a block diagram conceptually illustrating at least a portion of an exemplary data processing system 100 in which embodiments of the invention may be implemented. In the illustrative data processing system 100, two master devices, M0 and M1, as well as four slave devices, S0-S3, are connected through a bus interconnect 110, although embodiments of the invention are not limited to any specific number of master or slave devices. The master devices M0, M1 may comprise, for example, data processors, DMA (direct memory access) controllers, etc., while the slave devices S0-S3 may comprise, for example, various memory devices (e.g., read-only memory (ROM) devices, random access memory (RAM) devices, dynamic random access memory (DRAM), static random access memory (SRAM), content-addressable memory (CAM), flash memory, etc., without regard for whether the memory is embedded or not (e.g., discrete)) as well as various input/output (I/O) devices (e.g., memory peripherals, video peripherals, sound peripherals, sensor peripherals, network peripherals, and data processing peripherals). In a non-limiting embodiment of the invention, the data processing system 100 may comprise, for example, a system-on-a-chip (SoC) such as that which might be found in an embedded system.

As is known in data processing systems with memory-mapped I/O, each slave device S0-S3 in the data processing system 100, whether it is a memory device or an I/O device, is mapped onto its own region of the data processing system's address space and is enabled when one of the data processors M0, M1 asserts an address within that slave device's mapped address region on the bus interconnect 110.

The masters M0, M1 and slaves S0-S3 in the data processing system 100 might be running at different frequencies and/or utilizing different protocols, as is often the case. Hence, a transaction that starts from a given master and ends at a corresponding slave or slaves running a different protocol relative to the master will require various transformation phases when an access is initiated by the master. The bus interconnect 110 routes transactions based at least in part on the slave address space as per a system memory map. Any address space not occupied by the slaves is generally allocated as reserved space, and any accesses to such reserved spaces are directed to a “dummy slave” device for response (e.g., generating an error message, etc.). The dummy slave generates a fixed response to the master which is not controllable using a standard bus interconnect architecture.

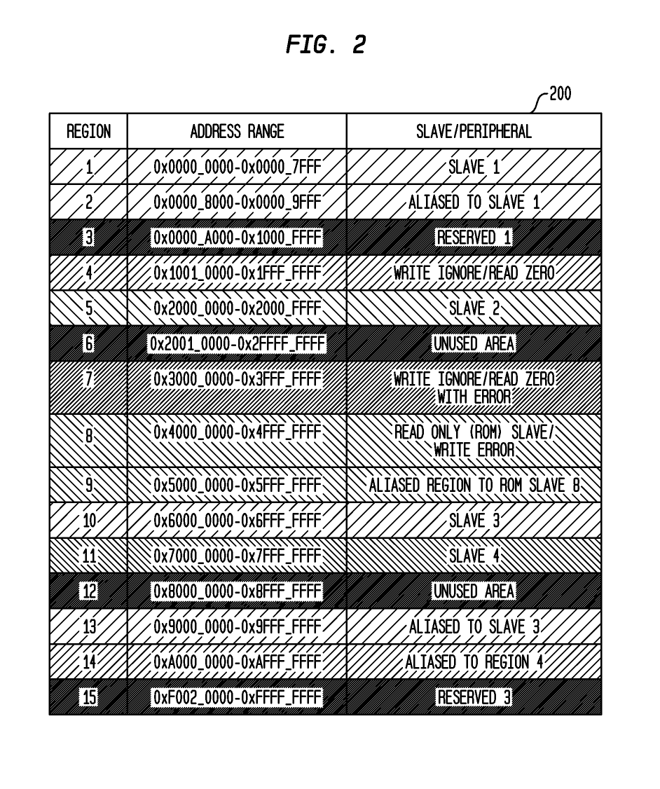

By way of illustration only and without loss of generality, FIG. 2 is a table 200 conceptually depicting an exemplary system memory mapping for a 4 GB address space. As apparent from FIG. 2, the address space is divided into multiple regions (fifteen in this example), with slaves/peripherals associated with various attributes, including read only (e.g., region 8), etc. It is to be appreciated that embodiments of the invention are not limited to any specific number or sizes of the regions. Additionally, some regions are designated as reserved or unused (e.g., regions 3, 6, 12 and 15) and therefore not associated with any specific peripherals or any specific slave/peripheral actions. Unused regions are typically aliased to the accessible address spaces. Although not explicitly shown in this example, some of the address space regions might be designated as non-accessible, where secure code may reside, and may even generate a decode error if not implemented. As stated above, dummy slave devices, in conventional systems, are required to handle responses to address spaces not occupied by the other slave devices.

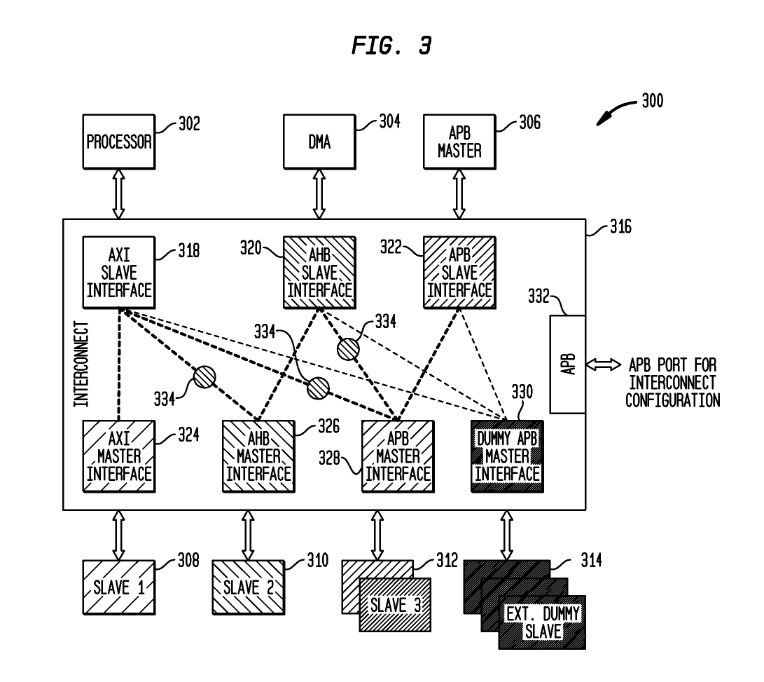

With reference now to FIG. 3, a block diagram depicts at least a portion of an exemplary data processing system 300 configurable for implementing the memory mapping shown in FIG. 2. The system 300 includes a plurality of master units, namely, a processor 302, a direct memory access (DMA) controller 304 and an Advanced Peripheral Bus (APB) master unit 306, or alternative programmable interface unit/controller. The master units 302, 304 and 306 are in operative communication with a plurality of slave units/peripherals, namely, SLAVE 1 308, SLAVE 2 310, SLAVE 3 312 and an external dummy slave 314, through a bus interconnect 316.

The bus interconnect 316 includes, by way of illustration only, an Advanced eXtensible Interface (AXI) slave interface module 318, an Advanced High-performance Bus (AHB) slave interface module 320 and an APB slave interface module 322 each operatively coupled with one or more of an AXI master interface module 324, an AHB master interface module 326, an APB master interface module 328 and a dummy APB master interface module 330, as shown by dotted lines indicative of respective data paths. From the standpoint of the bus interconnect, modules 318, 320 and 322 are referred to herein as “slave interface modules,” since they act as slaves for the corresponding master units 302, 304 and 306, respectively, with which they communicate. Likewise, modules 324, 326, 328 and 330 are referred to herein as “master interface modules,” since they act as masters for the corresponding slave units 308, 310, 312 and 314, respectively, with which they communicate. While reference is made herein to certain protocols, including, for example, APB, AXI, AHB, it is to be appreciated that embodiments of the invention are not limited to these or any specific protocols; rather, embodiments of the invention are well-suited for use with any programmable interface.

The AXI slave interface module 318 is operative essentially as a port for communicating with corresponding processor 302. Likewise, the AHB slave interface module 320 is operative as a port for communicating with corresponding DMA controller 304, the APB slave interface module 322 is operative for communicating with corresponding APB master unit 306, the AXI master interface module 324 is operative as a port for communicating with corresponding slave peripheral 308, the AHB master interface module 326 is operative as a port for communicating with corresponding slave peripheral 310, the APB master interface module 328 is operative as a port for communicating with corresponding slave peripheral 312, and the dummy APB master interface module 330 is operative as a port for communicating with corresponding dummy slave unit 314. An APB port 332 in the bus interconnect 316 provides access for configuring the bus interconnect.

As previously stated, one or more of the masters 302, 304, 306 and slaves 308, 310, 312, 314 in the system 300 might support different operating parameters relative to one another, such as, for example, utilizing different operating frequencies, communication protocols, data bus widths, data transmission rates, etc. Consequently, a data path from a given master to a corresponding slave might go through multiple translation phases to handle the various protocols, frequencies, data widths, etc., across the interconnect interfaces.

By way of illustration only, translation phases associated with a transaction between a given master unit and a corresponding slave unit might be represented as follows: master output→slave interface of interconnect→data width conversion→protocol conversion→frequency conversion→master interface of interconnect→slave input. In FIG. 3, the “bubbles” 334 in the bus interconnect 316 represent translation modules residing in respective data/control paths between interfacing master and slave modules within the bus interconnect. Each translation module 334 may be configured to perform more than one translation phase, although the translation module is not programmable. Rather translation module 334 represents a totality of all transaction that may occur in moving data from a slave interface module to a corresponding master interface module.

The particular cross-hatch pattern assigned to each of the slave units 308, 310, 312, 314 depicted in FIG. 3 is indicative of the type of slave unit as defined in the illustrative system memory map 200 shown in FIG. 2. Each slave unit that is shown multiple times (e.g., slave units 312 and 314) represents multiple regions in the system memory map 200, with each instantiation of a given slave unit representing a corresponding slave response pertaining to that memory region. These responses are generated by building dummy slave units for all of the accesses made to the address spaces left unoccupied by the remaining slave units in the system.

For example, each of the four external dummy slave units 314 are adapted to respond differently to address regions 3, 6, 12 and 15 (see FIG. 2), as defined by the memory address space. Here, the system dummy slave units 314 are capable of generating various types of responses, with each dummy slave unit being capable of generating only one type of response. Illustrative responses may include, but are not limited to, one or more of the following:

write ignore with okay response; read return zero with okay response

write ignore with error response; read return invalid data with error response

read only region slave access error

error on opcode fetch from this region

The type of response generated depends on the interconnect design/configuration, but it remains fixed for all master accesses such as, for example, in the case of an unused address space for decode error generation.

In some applications, a master device may expect an “okay” response for a particular reserved space access, with an error response for another reserved space access. Furthermore, this dummy slave implementation employed by the system 300 does not provide flexibility if varied responses are needed for different masters. For example, if region 2 (address range 0x0000_{—}8000-0x0000_{—}9FFF in FIG. 2) is addressed for a “read zero write ignore” response, a slave with a write path unconnected and a read path tied to zero is required for generating such response. Similarly, for regions 8 and 9 (address ranges 0x4000_{—}0000-0x4FFF_FFFF and 0x5000_{—}0000-0x5FFF_FFFF, respectively, in FIG. 2), write accesses are to be responded with an error message generated by slave 310. Standard IP (intellectual property) blocks like slave unit 310 usually do not provide such required customization. Hence, slave unit 310 is added to respond with an error for write accesses.

When a valid address space with a predictable response is desired, dummy slaves must be instantiated with the desired capability. A workaround to this problem is to add different dummy slaves with different response types based on the system memory map. However, the interconnect architecture in system 300, which only allows varying responses through the addition of customized slave blocks (e.g., dummy slave blocks 314), significantly increases integrated circuit area utilization and impacts performance of the system proportional to the complexity of the slave protocol employed. Moreover, the required additional interconnect congestion, as well as increased power consumption, attributable to the added slave blocks will further degrade system performance.

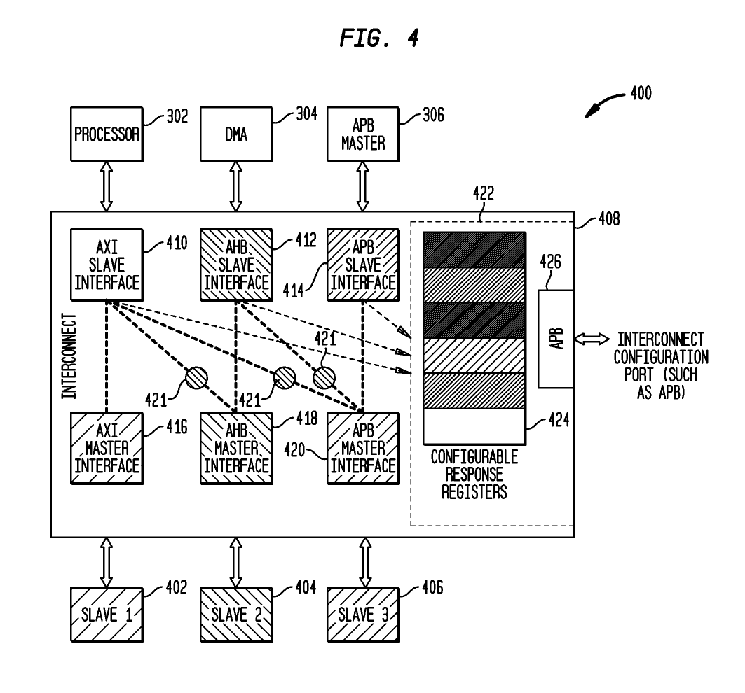

FIG. 4 is a block diagram depicting at least a portion of an exemplary data processing system 400, according to an embodiment of the invention. The data processing system 400, like the system 300 shown in FIG. 3, includes a plurality of master units, namely, processor 302, DMA controller 304 and APB master unit 306. The master units 302, 304 and 306 are in operative communication with a plurality of slave units, namely, SLAVE 1 402, SLAVE 2 404, and SLAVE 3 406, through a bus interconnect 408. As will be described in further detail below, the bus interconnect 408 is operative to provide configurable responses for varied regions of system address space, thereby eliminating a need for multiple instantiations of a given slave unit. The requirement of adding one or more customized dummy slave units (e.g., 314 in FIG. 3) is also beneficially eliminated by using the bus interconnect 408 in accordance with embodiments of the invention.

The bus interconnect 408 comprises a plurality of interface modules, including, by way of illustration only, an AXI slave interface module 410, an AHB slave interface module 412 and an APB slave interface module 414, each operatively coupled with one or more of an AXI master interface module 416, an AHB master interface module 418 and an APB master interface module 420, as shown by dotted lines indicative of respective data paths. From the standpoint of the bus interconnect 408, modules 410, 412 and 414 are referred to herein as “slave interface modules,” since they act as slaves for the corresponding master units 302, 304 and 306, respectively, with which they communicate. Likewise, modules 416, 418 and 420 are referred to herein as “master interface modules,” since they act as masters for the corresponding slave units 402, 404 and 406, respectively, with which they communicate. While reference is made herein to certain protocols, including, for example, APB, AXI and AHB, it is to be appreciated that embodiments of the invention are not limited to these or any particular protocols; rather, embodiments of the invention are well-suited for use with any programmable interface.

The AXI slave interface module 410 is operative as a port for communicating with corresponding processor 302. Likewise, the AHB slave interface module 412 is operative as a port for communicating with corresponding DMA controller 304, the APB slave interface module 414 is operative for communicating with corresponding APB master unit 306, the AXI master interface module 416 is operative as a port for communicating with corresponding slave peripheral 402, the AHB master interface module 418 is operative as a port for communicating with corresponding slave peripheral 404, and the APB master interface module 420 is operative as a port for communicating with corresponding slave peripheral 406. It is to be understood that embodiments of the invention are not limited to any specific number or type of interface modules included in the bus interconnect 408.

A plurality of translation modules 421 are included in the bus interconnect 408. Each of the translation modules 421 is connected in a corresponding master-slave interface path between a given master interface module and a given slave interface module. More particularly, the translation modules 421 reside in one or more data/control paths between slave interface modules (e.g., 410, 412, 414) and master interface modules (e.g., 416, 418, 420) within the bus interconnect 408. For example, a first of the translation modules 421 resides between the AXI slave interface module 410 and the AHB master interface module 418, a second of the translation modules 421 resides between the AXI slave interface module 410 and the APB master interface module 420, and a third of the translation modules 421 resides between the AHB slave interface module 412 and the APB master interface module 420.

Each translation module 421 is operative to perform a translation (e.g., protocol or other data translation) corresponding to the particular master-slave interface path in which the translation module is connected. For example, a translation module 421 utilized in the data/control path between the AXI slave interface module 410 and the AHB master interface module 418 is operative to perform data translation between an AXI protocol and an AHB protocol. Thus, the translation module 421 can be thought of as a composite representation of multiple functions, including, but not limited to, protocol conversion, data width conversation, frequency translation, clock domain translation, etc., as required by the corresponding master and slave interface paths. For a data/control path between a slave interface module and a master interface module utilizing the same or compatible protocols (e.g., between modules 410 and 416, or between modules 414 and 420), no translation module is required.

The bus interconnect 408 comprises a configurable response module 422 which includes a set of registers 424, referred to herein as configurable response registers, which are configurable (i.e., programmable) to generate different response types for each associated address region. In an alternative embodiment, each of at least a subset of the address regions is divided into a plurality of sub-regions, with each of the sub-regions of the address space having a corresponding response associated therewith. Moreover, each register may be associated with multiple regions and/or sub-regions of the system address space. The bus interconnect 408 is thus able to support multiple response types without the need for adding customized dummy slave units for the different response types and/or translation modules, with such functions being handled through the configurable response module 422. The configurable registers 424 are programmed using a programming interface, such as, for example, an APB port 426, or other low-bandwidth slave interface, in the configurable response module 422. The APB port 426 may be used to control other programmable parameters and configurations in the bus interconnect 408 as well, including, but not limited to, quality of service (QoS) parameters, arbitration schemes, etc. At least a subset of the configurable responses generated by the configurable response module 422 can be dynamically changed by programming (e.g., by a user via the APB port 426) at least one of the registers 424 or one or more bit fields associated with each of the registers.

By incorporating configurable response registers 424 in the bus interconnect 408, the dummy slave APB interface module 330 shown in FIG. 3, along with the need for external dummy slave devices (e.g., dummy slave 314), are advantageously eliminated, thereby considerably reducing logic gate count and reducing undesired congestion within the bus interconnect. From a cost-benefit perspective, the amount of additional logic overhead required to implement the configurable response module 422 is minimal compared to the reduction in interconnect area and congestion provided by the configurable response module. Furthermore, system performance is improved because the interconnect according to embodiments of the invention has fewer transactions to handle compared to implementations which do not employ the configurable response module 422.

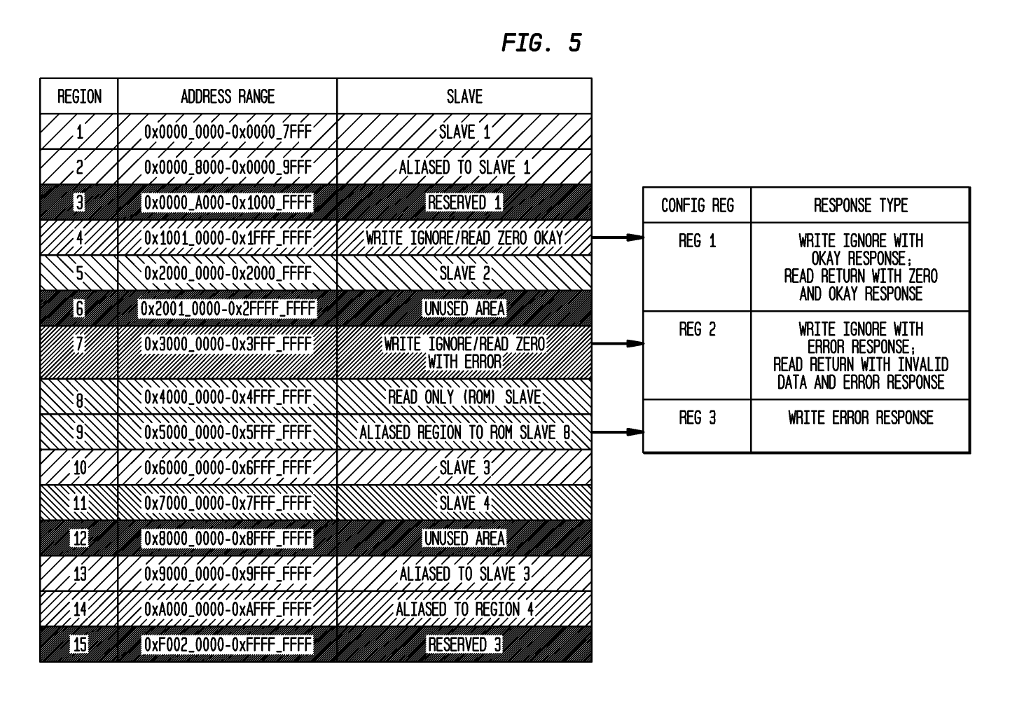

Whenever a master accesses a reserved memory space (e.g., Reserved space 1—Region 3 in the illustrative mapping shown in FIG. 2), a response is returned to the master based on the configuration registers 424. FIG. 5 conceptually depicts an exemplary mapping between the system memory mapping for a 4-GB address space, as illustrated in FIG. 2, and configurable response registers, according to an embodiment of the invention. In this example, only three configurable response registers are shown, although it is to be understood that embodiments of the invention are not limited to any specific number of registers.

With reference to FIG. 5, when a master device sends a request to access the address range designated as region 4 (e.g., 0x1001_{—}0000 to 0x1FFF_FFFF), a first configuration register (Reg 1) generates a “write ignore with OKAY response; read return with zero and OKAY response.” Likewise, when a master device sends a request to access the address range designated as region 7 (e.g., 0x3000_{—}0000 to 0x3FFF_FFFF), a second configuration register (Reg 2) generates a “write ignore with ERROR response; read return with invalid data and ERROR response.” And when a master device sends a request to access the address range designated as region 9 (e.g., 0x5000_{—}0000 to 0x5FFF_FFFF), a third configuration register (Reg 3) generates a “write error response.” This approach according to embodiments of the invention leads to an improved handling of multiple response types corresponding to reserved spaces, unused spaces, and valid address space in a system, thereby reducing logic, bus interconnect congestion and power consumption, among other benefits.

Embodiments of the invention can employ hardware, software, or hardware and software aspects. Software includes but is not limited to firmware, resident software, microcode, etc. One or more embodiments of the invention or portions thereof may be implemented in the form of an article of manufacture including a machine readable medium that contains one or more programs which when executed implement method step(s) used to perform at least portions of embodiments of the invention; that is to say, a computer program product including a tangible computer readable recordable storage medium (or multiple such media) with computer usable program code stored thereon in a non-transitory manner for performing one or more of the method steps indicated. Furthermore, one or more embodiments of the invention or elements thereof can be implemented in the form of an apparatus including a memory and at least one processor (e.g., master device) coupled with the memory and operative to perform, or facilitate the performance of, exemplary method steps.

As used herein, “facilitating” an action includes performing the action, making the action easier, helping to carry out the action, or causing the action to be performed. Thus, by way of example only and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

Yet further, in another aspect, one or more embodiments of the invention or elements thereof can be implemented in the form of means for carrying out one or more of the method steps described herein; the means can include (i) hardware module(s), (ii) software module(s) executing on one or more hardware processors, or (iii) a combination of hardware and software modules; any of (i)-(iii) implement the specific techniques set forth herein, and the software modules are stored in a tangible computer-readable recordable storage medium (or multiple such media). Appropriate interconnections via bus, network, and the like can also be included.

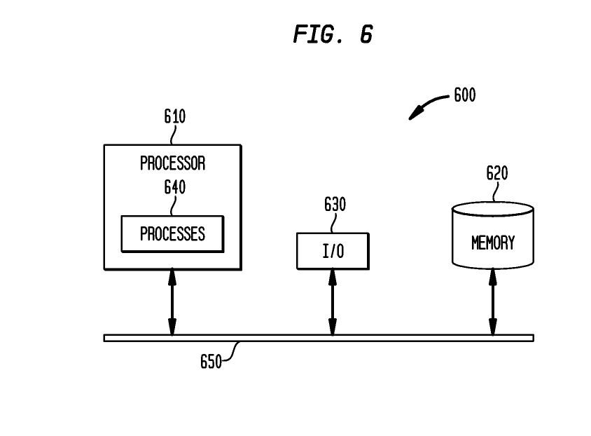

Embodiments of the invention may be particularly well-suited for use in an electronic device or alternative system (e.g., multiprocessor systems, multilayer and multilevel interconnect systems, memory storage systems, etc.). For example, FIG. 6 is a block diagram depicting at least a portion of an exemplary processing system 600 according to an embodiment of the invention. System 600, which may represent, for example, a multiprocessor SoC interconnect, or a portion thereof, includes a processor 610 (e.g., processor 302, DMA controller 304, or APB master device 306 shown in FIG. 4), memory 620 coupled with the processor (e.g., via a bus 650 or alternative connection means) or embedded in the processor, as well as I/O circuitry 630 operative to interface with the processor. The processor 610 may be configured to perform at least a portion of the functions according to embodiments of the invention (e.g., by way of one or more processes 640 which may be stored in memory 620 and loaded into processor 610), illustrative embodiments of which are shown in the previous figures and described herein above.

It is to be appreciated that the term “processor” as used herein is intended to include any processing device, such as, for example, one that includes a central processing unit (CPU) and/or other processing circuitry (e.g., network processor, microprocessor, digital signal processor, etc.). Additionally, it is to be understood that a processor may refer to more than one processing device, and that various elements associated with a processing device may be shared by other processing devices. The term “memory” as used herein is intended to include memory and other computer-readable media associated with a processor or CPU, such as, for example, RAM, read only memory (ROM), fixed storage media (e.g., a hard drive), removable storage media (e.g., a diskette), flash memory, etc. Furthermore, the term “I/O circuitry” as used herein is intended to include, for example, one or more input devices (e.g., keyboard, mouse, etc.) for entering data to the processor, and/or one or more output devices (e.g., display, etc.) for presenting results associated with the processor.

Accordingly, an application program, or software components thereof, including instructions or code for performing methodologies according to embodiments of the invention, as described herein, may be stored in a non-transitory manner in one or more of the associated storage media (e.g., ROM, fixed or removable storage) and, when ready to be utilized, loaded in whole or in part (e.g., into RAM) and executed by the processor. In any case, it is to be appreciated that at least a portion of the components shown in the previous figures may be implemented in various forms of hardware, software, or combinations thereof (e.g., one or more microprocessors with associated memory, application-specific integrated circuit(s) (ASICs), functional circuitry, one or more operatively programmed general purpose digital computers with associated memory, etc). Given the teachings of the embodiments of the invention provided herein, one of ordinary skill in the art will be able to contemplate other implementations of the embodiments of the invention.

At least a portion of the embodiments of the invention may be implemented in an integrated circuit. In forming integrated circuits, identical die are typically fabricated in a repeated pattern on a surface of a semiconductor wafer. Each die includes a device described herein, and may include other structures and/or circuits. The individual die are cut or diced from the wafer, then packaged as an integrated circuit. One skilled in the art would know how to dice wafers and package die to produce integrated circuits. Integrated circuits so manufactured are considered part of this invention.

An integrated circuit in accordance with embodiments of the invention can be employed in essentially any application and/or electronic system in which multiple processors or a bus interconnect may be employed. Suitable systems for implementing techniques of embodiments of the invention may include, but are not limited to, servers, personal computers, data storage networks, etc. Systems incorporating such integrated circuits are considered part of embodiments of the invention. Given the teachings of embodiments of the invention provided herein, one of ordinary skill in the art will be able to contemplate other implementations and applications of the techniques of embodiments of the invention.

The illustrations of embodiments of the invention described herein are intended to provide a general understanding of the structure of various embodiments, and they are not intended to serve as a complete description of all the elements and features of apparatus and systems that might make use of the structures described herein. Many other embodiments will become apparent to those skilled in the art given the teachings herein; other embodiments are utilized and derived therefrom, such that structural and logical substitutions and changes can be made without departing from the scope of this disclosure. The drawings are also merely representational and are not drawn to scale. Accordingly, the specification and drawings are to be regarded in an illustrative rather than a restrictive sense.

Embodiments of the inventive subject matter are referred to herein, individually and/or collectively, by the term “embodiment” merely for convenience and without intending to limit the scope of this application to any single embodiment or inventive concept if more than one is, in fact, shown. Thus, although specific embodiments have been illustrated and described herein, it should be understood that an arrangement achieving the same purpose can be substituted for the specific embodiment(s) shown; that is, this disclosure is intended to cover any and all adaptations or variations of various embodiments. Combinations of the above embodiments, and other embodiments not specifically described herein, will become apparent to those of skill in the art given the teachings herein.

The abstract is provided to comply with 37 C.F.R. §1.72(b), which requires an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the appended claims reflect, inventive subject matter lies in less than all features of a single embodiment. Thus the following claims are hereby incorporated into the Detailed Description, with each claim standing on its own as separately claimed subject matter.

Given the teachings of embodiments of the invention provided herein, one of ordinary skill in the art will be able to contemplate other implementations and applications of the techniques of embodiments of the invention. Although illustrative embodiments of the invention have been described herein with reference to the accompanying drawings, it is to be understood that embodiments of the invention are not limited to those precise embodiments, and that various other changes and modifications are made therein by one skilled in the art without departing from the scope of the appended claims.

What is claimed is:

1. A bus interconnect for interconnecting one or more master devices with one or more slave devices in a system, the bus interconnect comprising:
at least one slave interface module adapted for communicating with a corresponding one of the master devices;
at least one master interface module adapted for communicating with a corresponding one of the slave devices; and
a configurable response module coupled with the at least one slave interface module, the configurable response module being operative to generate different configurable responses associated with access requests to corresponding portions of an address space of the system.

2. The bus interconnect of claim 1, wherein the address space of the system is divided into a plurality of regions, each of the regions of the address space having a corresponding response associated therewith.

3. The bus interconnect of claim 2, wherein at least two of the regions have different responses associated therewith relative to one another.

4. The bus interconnect of claim 1, wherein the address space of the system is divided into a plurality of regions, each of the regions being further divided into a plurality of sub-regions, each of the sub-regions of the address space having a corresponding response associated therewith.

5. The bus interconnect of claim 1, wherein the configurable response module comprises a plurality of registers, each of the registers being associated with at least one region of the system address space and being operative to generate a response corresponding to the at least one region.

6. The bus interconnect of claim 5, wherein the configurable response module comprises a programming interface operative to provide access to the plurality of registers for programming at least one of the plurality of registers in the configurable response module.

7. The bus interconnect of claim 6, wherein the programming interface comprises at least one of an Advanced Peripheral Bus port, an Advanced eXtensible Interface port, a Universal Serial Bus port, and an Advanced High-performance Bus port.

8. The bus interconnect of claim 5, wherein each of the registers corresponds to multiple regions of the system address space.

9. The bus interconnect of claim 1, wherein the configurable response module comprises a plurality of registers, each of at least a subset of the registers having one or more bit fields associated therewith, each of the register bit fields corresponding to at least one region of the system address space and being operative to generate a response corresponding to the at least one region.

10. The bus interconnect of claim 9, wherein each of the register bit fields corresponds to multiple regions of the system address space.

11. The bus interconnect of claim 1, wherein the bus interconnect is operative to eliminate a need for a separate master interface module for generating a response to a master device requesting access to at least one of an unused region and a reserved region of the address space of the system.

12. The bus interconnect of claim 1, further comprising at least one translation module connected in a master-slave interface path between the at least one slave interface module and the at least one master interface module, the translation module being operative to perform a data translation corresponding to the master-slave interface path in which the translation module is connected to thereby facilitate communication between a corresponding master device and a corresponding slave device.

13. The bus interconnect of claim 1, wherein the configurable response module is configured so as to enable at least a subset of the configurable responses generated by the configurable response module to be dynamically changed.

14. The bus interconnect of claim 1, wherein at least a subset of the configurable responses generated by the configurable response module are dynamically changed by programming at least one register in the configurable response module.

15. The bus interconnect of claim 1, wherein at least a subset of the configurable responses generated by the configurable response module are user programmable.

16. The bus interconnect of claim 1, wherein at least a portion of the bus interconnect is fabricated in at least one integrated circuit.

17. A data processing system, comprising:
one or more master devices;
one or more slave devices; and
a bus interconnect coupled with the one or more master devices and the one or more slave devices, the bus interconnect comprising:
at least one slave interface module adapted for communicating with a corresponding one of the master devices;
at least one master interface module adapted for communicating with a corresponding one of the slave devices; and
a configurable response module coupled with the at least one slave interface module, the configurable response module being operative to generate different configurable responses associated with access requests to corresponding portions of an address space of the system.

18. The system of claim 17, wherein each of the one or more master devices comprises one of a processor, a direct memory access controller and a programmable interface controller.

19. The system of claim 17, wherein the configurable response module comprises a plurality of registers, each of the registers being associated with at least one region of the system address space and being operative to generate a response corresponding to the at least one region.

20. The system of claim 19, wherein the configurable response module comprises a programming interface operative to provide access to the plurality of registers for programming at least one of the plurality of registers in the configurable response module.

21. The system of claim 20, wherein the programming interface comprises at least one of an Advanced Peripheral Bus port, an Advanced eXtensible Interface port, a Universal Serial Bus port, and an Advanced High-performance Bus port.

22. The system of claim 17, wherein the bus interconnect is operative to eliminate a need for a separate master interface module for generating a response to a master device requesting access to at least one of an unused region and a reserved region of the address space of the system.

23. The system of claim 17, wherein the bus interconnect further comprises at least one translation module connected in a master-slave interface path between the at least one slave interface module and the at least one master interface module, the translation module being operative to perform a data translation corresponding to the master-slave interface path in which the translation module is connected to thereby facilitate communication between a corresponding master device and a corresponding slave device.

24. The system of claim 23, wherein the data translation performed by the translation module comprises at least one of protocol conversion, data width conversation, frequency translation, and clock domain translation.
